(19) United States
(12) Patent Application Publication
(10) Pub. No.: US 2008/0173421 A1
(43) Pub. Date: Jul. 24, 2008

(54) Investment Casting Process

(76) Inventor: Samantha Jones, West Midlands (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/587,425

(22) PCT Filed: Feb. 7, 2005
(86) PCT No.: PCT/GB05/00408

§ 371 Date: Nov. 5, 2007

(30) Foreign Application Priority Data
Feb. 5, 2004 (GB) 0402516.9

(51) Int. Cl. B22C 1/22; B22C 9/02; B05D 3/02; B05D 1/24

(52) U.S. Cl. 164/361; 427/203; 427/185; 427/204; 427/190

(57) ABSTRACT

A process for the production of a shell mould, comprising the sequential steps of: (i) dipping a preformed expendable pattern into a slurry of refractory particles and colloidal liquid binder whereby to form a coating layer on the pattern, (ii) depositing particles of refractory material onto the coating, and (iii) drying, steps (i) to (iii) being repeated as often as required to produce a shell mould having the required number of coating layers, characterised in that during at least one performance of step (ii) the particles of refractory material have been pre-mixed with a gel-forming material whereby to coat at least a portion of the refractory particles with the gel forming material such that after contact with the coating layer moisture is absorbed by the gel-forming material thereby causing gellation of the colloidal binder so reducing the time required for drying in step (iii).

The present invention relates to an improved investment casting process, and in particular to a process which is much more rapid than conventional processes.

A typical investment casting process involves the production of engineering metal castings using an expendable pattern. The pattern is a complex blend of resin, filler and wax (or other vaporisable material such as expanded polystyrene) which is injected into a metal die under pressure. Several such patterns, once solidified are assembled into a cluster and mounted onto a wax runner system. The wax assembly is dipped into a refractory slurry consisting of a liquid binder and a refractory powder. After draining, grains of refractory stucco are deposited onto the damp surface to produce the primary refractory coating (the covering of the assembly with refractory material is known as “investing”, hence the name for the process). When the primary coat has set (usually by air drying until the binder gels) the assembly is repeatedly dipped into a slurry and then stuccoed until the required thickness of mould shell is built up. Each coat is thoroughly hardened between dippings, and so each mould can take from between 24 and 72 hours to prepare. The purpose of the stucco is to minimise drying stresses in the coatings by presenting a number of distributed stress concentration centres which reduce the magnitude of any local stresses. Each stucco surface also provides a rough surface for keying in the next coating. The particle size of the stucco is increased as more coats are added to maintain maximum mould permeability and to provide bulk to the mould.

In recent years, advanced ceramics (e.g. silicon nitride) components have been developed which offer significant advantages over comparable metal components. Many processes by which such ceramic components can be made are known, and these include machining, injection moulding, slip casting, pressure casting and gelcasting. In gelcasting, a concentrated slurry of ceramic powder in a solution of organic monomer is poured into a mould and polymerised in situ to form a green body in the shape of the mould cavity. After demoulding, the green ceramic body is dried, machined if necessary, pyrolysed to remove binder and then sintered to full density. Aqueous based systems, such as the acrylamide system, have been developed in which water-soluble monomers are used, with water as the solvent.

It is an object of the present invention to provide an improved investment casting process which obviates or mitigates one or more problems associated with known investment casting processes and which preferably significantly reduces the time required for forming a shell mould.

According to the present invention, there is provided a process for the production of a shell mould, comprising the sequential steps of:
(i) dipping a preformed expendable pattern into a slurry of refractory particles and colloidal liquid binder whereby to form a coating layer on said pattern,
(ii) depositing particles of refractory material onto said coating, and
(iii) drying,
   steps (i) to (iii) being repeated as often as required to produce a shell mould having the required number of coating layers, characterised in that during at least one performance of step (ii) the particles of refractory material have been pre-mixed with a gel-forming material whereby to coat at least a portion of said refractory particles with said gel forming material such that after contact with the coating layer moisture is absorbed by the gel-forming material thereby causing gellation of the colloidal binder so reducing the time required for drying in step (iii).

Preferably, the method also includes the additional step (iv), carried out after the final step (iii) of applying a seal coat comprising a slurry of refractory particles and colloidal liquid binder, followed by drying.

In shell mould formation, the coating layer applied to the expendable pattern is usually referred to as the primary coating and subsequent slurry coatings are referred to as secondary coatings. Typically, three to twelve secondary coatings are applied.

Preferably, the gel-forming material-coated refractory particles are applied onto each secondary coating (i.e. during each repetition of step (ii) after the first). The gel-forming material-coated refractory particles may or may not be applied onto the primary coating.

It will be understood that the deposition of refractory particles (coated or un-coated) in step (ii) may be achieved by any convenient method, such as by use of a rainfall sander or a fluidised bed.

In a preferred embodiment, polymer coated and uncoated refractory particles are used in the same step (ii), e.g. the coated particles are pre-mixed with uncoated particles before application to the coating. In said preferred embodiment, the ratio of coated to uncoated particles may be from 95:5 to 5:95, more preferably 85:15 to 50:50 and most preferably about 75:25 by weight.

Preferably, the amount of gel-forming material used in step (ii) is no more than 5 wt % of the refractory material particles used in that step (ii), and more preferably no more than 2 wt %. Preferred ranges are 2.5 to 5 wt %, 1 to 2 wt % and 0.2 to 1 wt % and 0.15 to 0.5 wt %. The preferred range may be dependent on the method used to form the coated refractory particles as well as the size and nature of the refractory particles used. It will be understood that when the gel-forming material is used in more than one repetition of step (ii), the amount used in each step (ii) may differ.

Preferably, said gel-forming material is a polymer, more preferably a super absorbent polymer exemplified by polyacrylamide and polyacrylate. A particularly preferred polymer is a sodium salt of a cross-linked polyacrylic acid (e.g. that sold under the tradename Liquiblock 144).

Preferably, the method includes a step of coating the refractory particles with the gel-forming material. This may be achieved by mixing the gel-forming material with water to form a gel and subsequently mixing the refractory particles into the gel followed by drying (e.g. at elevated temperature or using microwaves) and grinding the resultant mass. Alternatively, the coating may be achieved by spray drying of the refractory particles, agglomeration or using a fluidised bed or any other suitable method. Although the particle size of the polymer is not critical, where the coating of the refractory particles is achieved by first mixing the polymer in water, better dispersion is found with smaller particles (e.g. about 300 μm or smaller).

It will also be understood that the required quantity of polymer can be achieved by a combination of (i) controlling the quantity of polymer used to form the coated particles, and (ii) the quantity of uncoated particles blended with the coated particles.

Advantageously, the process (apart from the use of the gel-forming material and the reduced drying times which result) can be substantially the same as a standard investment casting process using conventional machinery and materials. Thus, it will be understood that the nature of the expendable pattern, the slurry compositions used in step (i) (and step (iv) when present) and the refractory particles used in step (ii) may be any of those known to the person skilled in the art of investment casting. Typical examples of refractory materials include, by way of example only, silica, zirconium silicate, alumino-silicates, alumina.

Moreover, the method preferably includes a step of removing the expendable pattern from the shell mould after the last step (iii) (or step (iv) when present) and more preferably the method includes a final step of firing the resultant shell mould.

Firing may be effected by heating to 900° C. or more in conventional furnaces using conventional firing schedules. In certain embodiments, a multi-step firing procedure may be preferred. For example, a first step may involve heating to a temperature of from 400 to 700° C. at a heating rate of from 1 to 5° C./min (preferably 1 to 3° C./min), followed by a second step of heating to at least 900° C. (preferably about 1000° C.) at a rate of from 5 to 10° C./min. The temperature may be maintained between the first and second steps for a short period (e.g. less than 10 minutes). Heating to at least 900° C. may be effected in three or more steps if deemed necessary.

The present invention further resides in a shell mould producible by the method of the present invention.

The present invention will be further described with reference to the following examples.

### COMPARATIVE EXAMPLE 1

This comparative example was intended to be representative of a prior art standard shell used for aluminium alloy casting and was constructed as follows:

A filled-wax test piece was dipped into a first slurry (primary) for 30 seconds and drained for 60 seconds. Coarse-grained stucco material was then deposited onto the wet slurry surface by the rain fall sand method (deposition height about 10 cm). The coated test piece was placed on a drying carousel and dried for the required time under controlled conditions of low air movement. Extended drying removes moisture from the colloidal binder, forcing gellation of the particles to form a rigid gel.

Subsequent coats were applied by dipping (30 seconds) in a second (secondary) slurry followed by draining (60 seconds), with subsequent stucco application (rainfall sand method, deposition height about 10 cm) and drying for the required time after each stucco application. In total, four secondary coatings were applied. Finally, a seal coat was applied (dip in secondary slurry, but no stucco application), followed by drying.

The primary and secondary slurry specifications are contained in Table 1, with the other various process parameters being given in Table 2. The latex addition in Table 1 relates to the use of a water-based latex system, which is added to the base binder to improve unfired strength and reduce fired strength.

TABLE 1
Slurry specifications for aluminium shell preparation
(all figures are wt %)

| | binder silica | latex polymer | | refractory |
|---|---|---|---|---|
| | content | addition | | loading (wt % |
| Slurry | (wt %) | (wt %) | filler type | of total slurry) |
| Primary | 26 | 6 | (a) 200 mesh | 77% |
| | | | zircon | |
| | | | (b) 200 mesh | a:b 3:1 |
| | | | fused silica | |
| Secondary | 22 | 8 | 200 mesh | 57% |
| | | | fused silica | |

TABLE 2
Shell build specifications for comparative example 1

| | | Drying air speed | Drying time |
|---|---|---|---|
| Coating | Stucco | (ms⁻¹) | (mins) |
| primary | 50/80 mesh | 0.4 | 1440 |
| | alumino-silicate | | |
| secondary 1 | 30/80 mesh | 3 | 90 |
| | alumino-silicate | | |
| secondary 2 | 30/80 mesh | 3 | 90 |
| | alumino-silicate | | |
| secondary 3 | 30/80 mesh | 3 | 90 |
| | alumino-silicate | | |
| secondary 4 | 30/80 mesh | 3 | 90 |
| | alumino-silicate | | |
| seal coat | none | 3 | 1440 |
| | | Total | 3240 |

### COMPARATIVE EXAMPLE 2

The shell mould according to comparative example 2 was made in the same manner as for comparative example 1 using the slurries of Table 1, except that the stucco applied onto the primary and all the secondary coatings included particles of polyacrylate (at a loading of 1 part polyacrylamide to 40 parts stucco). The process parameters are given in Table 3. When the polyacrylate is deposited onto the wet slurry surface, it rapidly absorbs moisture from the adjacent colloidal portion of the slurry forcing gellation to a rigid gel without the necessity of extended drying times.

TABLE 3
Shell build specifications for comparative example 2

| | | Drying air | Drying |
|---|---|---|---|
| Coating | Stucco | speed (ms⁻¹) | time (mins) |
| primary | 50/80 mesh alumino-silicate | 0.4 | 10 |
| | Liquiblock 144 (2.5 wt %)* | | |
| secondary | 30/80 mesh alumino-silicate | 3 | 5 |
| 1 | Liquiblock 144 (2.5 wt %)* | | |
| secondary | 30/80 mesh alumino-silicate | 3 | 5 |
| 2 | Liquiblock 144 (2.5 wt %)* | | |
| secondary | 30/80 mesh alumino-silicate | 3 | 5 |
| 3 | Liquiblock 144 (2.5 wt %)* | | |
| secondary | 30/80 mesh alumino-silicate | 3 | 5 |
| 4 | Liquiblock 144 (2.5 wt %)* | | |
| seal coat | none | 3 | 1080 |
| | | Total | 1110 |

*polyacrylate having particle size < 300 μm

### EXAMPLE 1

A mixture of one part by weight of Liquiblock 144, 400 parts by weight of 50/80 mesh alumino-silicate and 400 parts by weight of deionised water was prepared and dried at 100° C. for 24 hours with occasional mixing. Small samples were fired at 1000° C. for 30 minutes and the percentage of polymer initially present determined by relating the percentage weight loss to burn-off of the polymer. Results indicated that the stucco contained 0.20% by weight of polymer. (The percentage of polymer is slightly less than the theoretical 0.25 wt % since some water is retained in the stucco.)

As an alternative stucco preparation, the polymer was mixed vigorously with water to form a viscous gel. The refractory particles were then added and held in suspension within the gel matrix. Drying was effected in 20 minutes using a microwave and resulted in a dry solid block. The block was then carefully reground to prevent major changes in particle size. This method ensures that substantially all the refractory particles are coated with polymer.

Ceramic slurries were made up as shown in Table 1, and ceramic mould samples were dipped according to Table 4 below, the method being as used for comparative examples 1 and 2.

TABLE 4
Shell Build For Example 1

| | | Drying air | Drying |
|---|---|---|---|
| Coating | Stucco | speed (ms⁻¹) | time (mins) |
| primary | 50/80 mesh alumino-silicate | 0.4 | 10 |
| | Liquiblock 144 (0.25 wt %)* | | |
| secondary | 30/80 mesh alumino-silicate | 3 | 10 |
| 1 | Liquiblock 144 (0.25 wt %)* | | |
| secondary | 30/80 mesh alumino-silicate | 3 | 10 |
| 2 | Liquiblock 144 (0.25 wt %)* | | |
| secondary | 30/80 mesh alumino-silicate | 3 | 10 |
| 3 | Liquiblock 144 (0.25 wt %)* | | |
| secondary | 30/80 mesh alumino-silicate | 3 | 10 |
| 4 | Liquiblock 144 (0.25 wt %)* | | |
| seal coat | none | 3 | 1080 |
| | | Total | 1130 |

### EXAMPLE 2

Example 1 was repeated with a four-fold increase in polymer (i.e. 1% theoretical).

### Shell Thickness Comparisons

Comparisons of the ceramic shell thickness achieved for comparative examples 1 and 2 and Example 1 and Example 2 shell systems can be seen in Table 5.

TABLE 5
Shell thickness comparison

| | | Average | standard |
|---|---|---|---|
| | | Thickness | deviation, σ⁻¹ |
| | status | (mm) | (mm) |
| Comparative | unfired | 4.99 | 0.39 |
| Example 1 | fired | 4.81 | 0.56 |
| Comparative | unfired | 9.42 | 0.36 |
| Example 2 | fired | 8.53 | 0.46 |
| Example 1 | unfired | 6.41 | 0.42 |
| | fired | 6.75 | 0.56 |
| Example 2 | unfired | 7.35 | 0.93 |
| | fired | 7.54? | 0.88 |

### Flat Bar Strength Measurement (MOR)

The modulus of rupture (MOR) is the maximum stress that a prismatic test piece of specified dimensions can withstand when it is loaded in the three-point bend mode. The principle of the test is the loading of test pieces at a constant rate of increase of stress until failure occurs. The test method has been widely used in industry, particularly to promote the properties of one mould material over another. The method of testing is standardised by the British Standard BS 1902-4.4:1995, which stipulates the method of testing and dimensional tolerances required to carry out the test correctly.

For MOR testing, the samples were prepared upon a wax pattern with dimensions of 200 mm×25 mm×10 mm thickness. After de-wax, the moulds were cut into rectangular test bars. The unfired and fired samples were tested at room temperature (18-21° C.).

To evaluate the effect of the de-wax procedure upon the mechanical strength of the shell systems, the unfired strength was measured dry (left at 21° C. for 12 hours prior to testing) and wet (placed above a steam bath at approximately 80-90° C. for 30 minutes prior to testing). Samples were loaded in an Instron 8500 tensile testing machine at a constant load rate of 1 mm/minute until failure.

The MOR, σ_{Max}, was calculated using equation 1

$${σ}_{Max} = \frac{3 {P}_{max} L}{2 {WH}^{2}} \qquad ( 1 )$$

where P_{Max} is the fracture load, W and H are the width and thickness of sample fracture area, L is the span length. The MOR, measured in the 3-point bend mode is an intrinsic material property unaffected by the dimensions of the test bar. Different thickness of shell affects the performance of the material, and an adjusted fracture load in bending (AFL_{B}) (defined as the load necessary to break a 10 mm wide shell test piece across a 70 mm span) was calculated. This value normalises the load bearing capacity of the shell and can be calculated using Equation 2.

AFL_{B}=f_{B}σ_{Max}H² (2)

where f_{B} is a constant equal to 0.1, i.e. normalising the data across a width of 10 cm.

Injected wax bars were used as the formers for the ceramic shells formed by the procedures indicated above. After formation, the shells were steam Boilerclave™ de-waxed at 8 Bar pressure for 4 minutes, followed by a controlled de-pressurisation cycle at 1 Bar/minute. Test pieces, approximately 20 mm×80 mm were cut using a grinding wheel and tested in a 3 point bend mode at room temperature (primary coat in compression).

A comparison of the maximum strengths achieved at room temperature in the 3-point bend mode for the shell samples is shown in Table 6. In addition to the green dry strength measurements, Examples 1 and 2 and comparative examples 1 and 2 were tested for their green wet strength (to simulate strength during de-waxing) and their fired strength under different heating regimes. These results are also shown in Table 6 below.

TABLE 6
Flat bar fracture strengths

| | | Fracture Strength | Adjusted |
|---|---|---|---|
| Example | Status | (MPa) | fracture load (N) |
| Comp. | green, dry | 4.86 +/− 0.54 | 12.0 |
| Example 1 | green, wet | 4.55 +/− 0.47 | 11.1 |
| | Fired (method A) | 4.24 +/− 0.61 | 9.7 |
| | Fired (method B) | 3.80+/− 0.38 | 9.1 |
| Comp. | green, dry | 2.80 +/− 0.75 | 24.8 |
| Example 2 | green, wet | 1.63 +/− 0.36 | 13.9 |
| | Fired (method B) | 1.32 +/− 0.32 | 9.5 |
| | Fired (method C) | 0.98 +/− 0.29 | 8.7 |
| Example 1 | green, dry | 2.11 +/− 0.16 | 8.3 |
| | green, wet | 1.29 +/− 0.16 | 5.6 |
| | Fired (method B) | 1.15 +/− 0.16 | 5.2 |
| | Fired (method C) | 1.18 +/− 0.09 | 5.1 |
| Example 2 | green, dry | 3.15 +/− 0.9 | 17.2 |
| | green, wet | 1.70 +/− 0.22 | 11.3 |
| | Fired (method A) | 1.86 +/− 0.37 | 9.7 |
| | Fired (method B) | 1.86 +/− 0.37 | 11.8 |
| | Fired (method C) | 2.05 +/− 0.33 | 11.2 |

Firing method A: to 1000° C. @ 20 C./min, dwell 60 min, furnace cool
Firing method B: to 700° C. @ 1 C./min, dwell 6 min, to 1000° C. @ 5 C./min, dwell 30 min, furnace cool
Firing method C: to 700° C. @ 2 C./min, dwell 6 min, to 1000° C. @ 10 C./min, dwell 60 min, furnace cool.

It should be noted that, as long as the fired strength is sufficient to hold the alloy being cast, lower shell strengths are actually advantageous for shell knock-out, particularly when casting relatively soft aluminium alloys.

Although the comparative example 2 shells were generally satisfactory, and can be produced much more quickly than the standard shells (comparative example 1), there was a tendency for the primary stucco coating to delaminate. On de-waxing and firing some cracking was also observed, although there was no metal breakout.

The de-lamination during shell manufacture and de-waxing may be due to the volume expansion of the individual polymer particles as water is absorbed and the particles ‘swell’. Another observed effect, “stripping”, may be due to the fact that the polymer is being introduced as a ‘discrete’ particle: not all the moisture from the slurry layer is being removed from the colloid phase as there will be a limit to the extent/rate of moisture transport through a capillary network. As the next layer is dipped, there will be an excess of moisture within the colloidal network, preventing gellation and catalysing ‘breakdown’ of the already gellated bonding structure. The expansion and cracking of the shell during firing is possibly due to a thermal mis-match between ceramic/colloid/polymer addition or expansion due to volatilisation of the polymer. Discrete particles will have a high concentration of polymer in one particular location leaving holes as this is removed.

In stark contrast, the Example 1 and Example 2 shells did not crack at all during de-waxing, with the entire shell (primary and secondary layers) remaining intact. After firing at the reduced heating rates (Methods B and C) the entire shell is whole with no observed delamination. The strengths are equivalent to the use of particle polymer additions but the fact that the entire shell remains intact means that the shells of the present invention will be superior for casting. Furthermore, it will be noted that the AFL values for Example 2 are comparable or higher than those for the unmodified standard shell comparative example 1, suggesting that this shell will actually have a higher load bearing capacity.

### Green and Fired Edge (Wedge) Strength Tests

The MOR test does not determine the ability of the mould to resist cracking in the most frequent site of mould failure during de-wax and casting, which is along the sharp radii and corners. This is frequently seen in products such as turbine blades, where the coverage of slurry and stucco will be critical. The edge test is used to evaluate the strength and load capacity of the shell mould at edges and corners (Leyland, S. P., Hyde, R., & Withey, P. A., The Fitness For Purpose of Investment Casting Shells, In Proceedings of 8^{th} International Symposium on Investment Casting (Precast 95), Czech Republic, Brno, 1995, 62-68).

For the edge test, instead of testing a plane mould surface, a wedge is forced into a specially designed test piece. The test piece is loaded such that the inner surface of the mould (the primary layer) is in tension and the outer surface in compression. Test pieces were taken from mould samples produced using a specially designed wax pattern which produces symmetric trailing edge sections. The length of the edge test sample was approximately 20 mm and the width of the sample 10 mm. Samples tested were green (dry and wet) and samples fired in accordance to the schedules listed above.

The load required to break the test piece was recorded and the fracture strength of the edge piece calculated using Equation 3,

$${σ}_{wedge} = 12.2 \frac{sin θ cos θ Fd}{{WT}^{2}} \qquad ( 3 )$$

where F is the fracture load applied to the wedge, d is the span length, W is the width and T is the thickness of edge test piece. The adjusted fracture load of the edge sample (AFL_{W}), defined as the load necessary to break a 10 mm wide edge test piece with a 20 mm span length, normalises the load bearing capacity of the shell at edges and can be calculated using Equation 4.

AFL_{W}=f_{W}σ_{Wedge}T² (4)

where f_{W} is a constant equal to 0.1.

Example 2 gave a shell structure that is completely undelaminated. Both green and fired samples were intact and sound. This suggests that the reduced polymer content not only reduces the level of wet-back during green manufacture, but also reduces the stress applied to the shell system during firing. It is believed that this combination of excess moisture and stresses generated during volatilisation of the polymer is the cause of delamination. Therefore, future shell systems need to be produced with the minimum level of polymer addition, a situation that will reduce shell build costs also. Table 7 shows the comparison in edge test results obtained (including AFL results) between comparative example 1 and Example 2.

TABLE 7
Comparison of the edge strength test results

| | | Edge Strength | Adjusted |
|---|---|---|---|
| Example | Status | (MPa) | fracture load (N) |
| Comp. | green, dry | 1.89 +/− 0.37 | 2.93 +/− 0.51 |
| Example 1 | green,wet | 1.65 +/− 0.23 | 2.90 +/− 0.59 |
| | Fired (method A) | 1.34 +/− 0.14 | 1.63 +/− 1.21 |
| | Fired (method B) | 1.58 +/− 0.27 | 2.25 +/− 0.46 |
| Example 2 | green, dry | 0.65 +/− 0.15 | 3.82 +/− 0.76 |
| | green, wet | 0.44 +/− 0.10 | 2.13 +/− 0.39 |
| | Fired (method A) | 0.39 +/− 0.08 | 2.43 +/− 1.47 |
| | Fired (method B) | 0.43 +/− 0.08 | 2.11 +/− 0.74 |
| | Fired (method C) | 0.42 +/− 0.07 | 2.03 +/− 0.93 |

The edge test results show that the Example 2 shell has a lower strength than the standard systems. However, the increased shell build on the vulnerable edge leads to an load bearing capacity (AFL) which is comparable i.e. the shell edges should withstand the same loads. The standard deviation of the thickness measurements is much higher for the Example 2 shell and is indicative of increase variability in shell structure. The increased variability of the shell thickness however, does not seem to affect the very consistent edge strength values exhibited by these shells. The results also show that the modified system can be fired at comparable rates to industry standards (fire A) without any detrimental effects, thus removing a need to reduce the firing rates for these specialised shells.

### Full Scale Casting Trials

### EXAMPLE 3

The casting trials undertaken at this stage of the project were to validate the rapid shell build method and its ability to produce industrial size castings in the current foundry environment. The moulds were produced in house by hand due to the large amount of materials required to run an industrial scale rain-sander using coated stucco material.

An assembly was produced with the test piece patterns injected in virgin wax (Remet Hyfill) and the running system in re-claimed wax. Shell dipping was carried out according to the procedure set out in Table 8 below, the stucco having been prepared as for Examples 1 and 2.

TABLE 8
Shell build specifications for Example 3

| | | Drying air | Drying |
|---|---|---|---|
| Coating | Stucco | speed (ms⁻¹) | time (mins) |
| primary | 50/80 mesh alumino-silicate | 0.4 | 10 |
| | Liquiblock 144 (1 wt %)* | | |
| secondary | 30/80 mesh alumino-silicate | 3 | 10 |
| 1 | Liquiblock 144 (1 wt %)* | | |
| secondary | 30/80 mesh alumino-silicate | 3 | 10 |
| 2 | Liquiblock 144 (1 wt %)* | | |
| secondary | 30/80 mesh alumino-silicate | 3 | 10 |
| 3 | Liquiblock 144 (2 wt %)* | | |
| secondary | 30/80 mesh alumino-silicate | 3 | 10 |
| 4 | Liquiblock 144 (2 wt %)* | | |
| seal coat | none | 3 | 720 |
| | | Total | 770 |

The wax assembly was packaged and transported to the Industrial foundry to be de-waxed in a full scale industrial Boilerclave unit. The de-wax schedule employed was:
1. 0 to 8.5 Bar (0.85 MPa) pressure in 10 seconds
2. Dwell at maximum pressure for 5 minutes
3. De-pressure to atmospheric in 10 minutes (0.8 Bar/minute)

The shell was fired in the industrial furnace under the following regime:
1. Introduced into furnace and ramped up to 450° C. (15° C./min approximately)
2. Ramped 450-800° C. (12° C./minute approximately)
3. Held at 800° C. for 30 minutes
4. Cast unbacked with LM25 (aluminium alloy) at approximately 800° C.
5. Air cooled

Comparative Example 2 (2.5 wt % stucco particle addition) casting using commercially pure aluminium exhibited primary coat delamination problems on the pouring cup. The casting did not show any major delamination in the bulk of the assembly, although there were signs of edge cracking and small amounts of primary loss. In contrast, the Example 3 shell exhibited no de-lamination of primary or secondary coats and no visible damage that has occurred during the wax removal. After firing the shell was cast with LM25, with the addition of a small amount of cement around the base of the test pieces (common practice for the foundry involved) although there were no signs of cracking or weakening at this point.

The shell is much weaker than the standard shell and is therefore relatively easy to remove. There were no signs of primary delamination and the casting was sound with a good surface finish. The trial to cast a rapidly produced industrial shell, under standard industrial dewax and casting conditions was successful.

### EXAMPLE 4

In order to further develop the shell system, a number of changes to the Example 3 process were adopted:
(i) further reduction in superabsorbing polymer content to reduce moisture pick-up during dipping
(ii) reduction/elimination of inter-coat air movements and times to promote fast manufacture
(iii) the use of standard primary production times (no polymer modification) to completely prevent primary coat delamination
(iv) ‘blowing’ off of loose slurry in between dippings to reduce delamination (standard procedure in Industry)
(v) the use of current Industrial de-wax and firing schedules.

In this example the casting to be produced was an IGT turbocharger. Shell dipping was carried out according to the procedure set out in Table 9 below, the stucco having been prepared as for Examples 1 and 2.

TABLE 9
Shell build specifications for Example 4

| | | Drying air | Drying |
|---|---|---|---|
| Coating | Stucco⁺ | speed (ms⁻¹) | time (mins) |
| primary | zircon sand | 0.1 | 420 |
| secondary | 30/80 mesh alumino-silicate | 0.1 | 20 |
| 1 | Liquiblock 144 (0.25 wt %)* | | |
| secondary | 30/80 mesh alumino-silicate | 1.5 | 20 |
| 2 | Liquiblock 144 (0.25 wt %)* | | |
| secondary | 18/36 mesh alumino-silicate | 3 | 80 |
| 3-7 | Liquiblock 144 (0.25 wt %)* | | |
| seal coat | none | 3 | 720 |
| | | Total | 1580 |

⁺Where polymer was used in the secondaries, the polymer pre-coated stucco material was pre-mixed with standard non-coated material in a ratio of coated to uncoated of 3:1.

De-waxing in a full scale industrial Boilerclave unit was carried out at a maximum pressure of 8 Bar (180° C., 0.8 MPa) for 10 minutes, with a depressurisation rate of 1 bar/minute.

The shell was fired in the industrial furnace under the following regime:
1. Introduced into furnace and ramped up to 900° C. (20° C./min approximately)
2. Held at 900° C. for 120 minutes
3. Furnace cooled.

After firing, a wash out was carried out to determine if there was any primary delamination (particles are washed out and visible) or through-cracks in the shell structure. A dye component in the wash water is used which permeates through cracks making them visible). In this case the shell was completely intact with no evidence of primary delamination.

Casting was effected using a nickel-based superalloy at 1600° C. under vacuum. Afterwards, the mould was intact, with no evidence of cracking, metal run-out or finning on the blade edges (indicative of edge shell cracks). This is again evident after de-moulding where there is no finning or irregular appearance to the casting.

Finally the casting was shot blasted, cleaned, heat treated and prepared for NDT testing and dimensional tolerance checks. The rapidly produced castings exhibited identical dimensions to those produced with a conventional shell and were completely sound and within the required dimensional tolerances.

Drying and strength-development of each coat in investment shell mould production is the most significant rate-limiting factor in the reduction of lead times and production costs for the industry. As such, improvements which reduce cost and cycle times open up enormous opportunities for product development, cost savings and the environmentally sound practice of decreased energy use. The fundamental need to remove sufficient moisture to gel the colloidal binder and develop sufficient green strength for re-dip has been overcome by finding an alternative method of rapidly removing the moisture from the colloid without drying. The alternative method, using a super absorbent polymer additive to rapidly remove the water and ‘lock’ it chemically within the polymeric structure has been developed for investment mould production, such that moisture removal by drying is not required to cause binder gellation. The system has been proven in industrial practice, requiring little capital cost or equipment replacement as current systems can easily be adapted. There is a huge potential for decreases in labour and material costs and the reduction in lead times from wax/casting can be greatly decreased allowing current components to be produced faster but also opening up the potential for new markets for a currently specialised production route (i.e. automotive and general engineering components).

1. A process for the production of a shell mould, comprising the sequential steps of:
(i) dipping a preformed expendable pattern into a slurry of refractory particles and colloidal liquid binder whereby to form a coating layer on said pattern,
(ii) depositing particles of refractory material onto said coating, and
(iii) drying,
steps (i) to (iii) being repeated as often as required to produce a shell mould having the required number of coating layers, characterised in that during at least one performance of step (ii) the particles of refractory material have been pre-mixed with a gel-forming material whereby to coat at least a portion of said refractory particles with said gel forming material such that after contact with the coating layer moisture is absorbed by the gel-forming material thereby causing gellation of the colloidal binder so reducing the time required for drying in step (iii).

2. The method of claim 1, including the additional step (iv), carried out after the final step (iii) of applying a seal coat comprising a slurry of refractory particles and colloidal liquid binder, followed by drying.

3. The method of claim 1, wherein the gel-forming material-coated refractory particles are applied during each repetition of step (ii) after the first.

4. The method of claim 1, wherein step (ii) is achieved using a rainfall sander.

5. The method of claim 1, wherein the amount of gel-forming material used in any performance of step (ii) is no more than 2 wt % of the refractory material particles used in that step (ii)

6. The method of claim 1, wherein said gel-forming material is a super absorbent polymer.

7. The method of claim 6, wherein said polymer is a polyacrylate.

8. The method of claim 1 additionally comprising a step of coating at least some of the refractory particles with the gel-forming material.

9. The method of claim 8, wherein the proportion of precoated to uncoated particles used in step (ii) is 75:25 by weight.

10. The method of claim 9, wherein said ratio is achieved by coating refractory particles with the gel-forming material and mixing said coated particles with uncoated particles.

11. The method of claim 8, wherein said coating step is effected by mixing the gel-forming material with water to form a gel and subsequently mixing the refractory particles into the gel followed by drying and grinding the resultant mass.

12. The method of claim 11, wherein said coating step is effected by spray drying of the refractory particles, agglomeration or using a fluidised bed.

13. The method of claim 1, wherein said refractory particles are silica, zirconium silicate, alumino-silicate, alumina or yttria particles.

14. The method of claim 1, including a step of removing the expendable pattern from the shell mould after the last step (iii), or step (iv) when present, and a final step of firing the resultant shell mould.

15. A shell mould producible by a process for the production of said shell mould, said process comprising:
(i) dipping a preformed expendable pattern into a slurry of refractory particles and colloidal liquid binder whereby to form a coating layer on said pattern,
(ii) depositing particles of refractory material onto said coating, and
(iii) drying,
wherein said steps (i) to (iii) being repeated as often as required to produce a shell mould having the required number of coating layers, characterised in that during at least one performance of step (ii) the particles of refractory material have been pre-mixed with a gel-forming material whereby to coat at least a portion of said refractory particles with said gel forming material such that after contact with the coating layer moisture is absorbed by the gel-forming material thereby causing gellation of the colloidal binder so reducing the time required for drying in step (iii).
